(19) United States
(12) Patent Application Publication
(10) Pub. No.: US 2016/0176454 A1
(43) Pub. Date: Jun. 23, 2016

(54) Seal Assembly for Track Pin Joint Assembly of Undercarriage

(71) Applicant: Caterpillar Inc., Peoria, IL (US)

(72) Inventors: Mark S. Diekevers, Germantown Hills, IL (US); Gregory J. Kaufmann, Peoria, IL (US); Darren B. Antoine, East Peoria, IL (US)

(73) Assignee: CATERPILLAR INC., Peoria, IL (US)

(21) Appl. No.: 14/946,416

(22) Filed: Nov. 19, 2015

Related U.S. Application Data
(60) Provisional application No. 62/095,548, filed on Dec. 22, 2014.

(51) Int. Cl. B62D 55/088; B62D 55/32; B62D 55/21

(52) U.S. Cl. CPC B62D 55/0887; B62D 55/21; B62D 55/32

(57) ABSTRACT

A track pin joint assembly includes a pin, a first link, a second link pivotable with respect to the first link about the pin, and a seal assembly. The seal assembly includes a seal ring, a load ring, and a seal lip. The load ring is mounted to the seal ring and is sealingly engaged with the first link. The seal lip is connected to the second link such that the seal lip circumscribes the pin passage of the second link and extends axially from the second link toward the seal ring. The seal lip is in sealing contact with the radial flange of the seal ring.

### CROSS-REFERENCE TO RELATED APPLICATION

This patent application claims the benefit of priority to U.S. Patent Application No. 62/095,548, filed Dec. 22, 2014, and entitled “Seal Assembly for Track Pin Joint Assembly of Undercarriage,” which application is incorporated in its entirety herein by this reference.

### TECHNICAL FIELD

This patent disclosure relates generally to an undercarriage for a track-type machine and, more particularly, to a seal assembly for use in a track pin joint assembly of the undercarriage.

### BACKGROUND

Track-type machines are in widespread use in construction, mining, forestry, and other similar industries. The undercarriage of such track-type machines utilizes track assemblies, rather than wheels, to provide ground-engaging propulsion. Such track assemblies may be preferred in environments where creating sufficient traction is problematic, such as those frequently found in the industries identified above. Specifically, rather than rolling across a work surface on wheels, track-type machines utilize one or more track assemblies that include an endless loop of coupled track links defining outer surfaces, which support ground-engaging track shoes, and inner surfaces that travel about one or more rotatable track-engaging elements, such as, drive sprockets, idlers, tensioners, and rollers, for example.

Typical track chain assembly designs include a track pin either fixedly or rotatably connected to a pair of chain links and a bushing rotatably positioned between the links and about the track pin. Such track chain assemblies can operate in extremely adverse environments in which track joints may be exposed to various abrasive mixtures of water, dirt, sand, rock or other mineral or chemical elements.

Track seals are disposed between the components of a track chain of a tracked undercarriage in order to seal the track chain against dirt, mud, and debris while retaining lubricants in the track chain. The failure of a seal within a track chain can accelerate wear and cause early failure of a portion of the track chain.

A common type of seal used in track chains is referred to as a “can” seal. A can seal often includes a “lip” supported by a can and a load ring engaging the can. The surface defining a seal cavity interacts with the load ring to apply a force to the can and lip combination. The lip engages a sealing surface of an adjacent component. The can seal, the surface of one component defining the seal cavity, and the sealing surface of the adjacent component cooperate together to provide a sealed interface to retain lubricant within the assembly and protect against dirt, mud, abrasive materials, debris and other contaminants. Examples of such can seals are shown and described in U.S. Patent Application Publication Nos. US 2007/0267821 and 2011/0254364; U.S. Pat. Nos. 6,739,680; 5,794,940; and 4,094,516; and International Application Publication No. WO 2008/093160 A1.

U.S. Pat. No. 4,295,654 is entitled, “Seal Assembly for a Linkage,” and is directed to a seal assembly for a joint of each pair of adjacent links of an endless track assembly. The seal assembly includes a wear-resistant elastomeric seal ring and a resilient elastomeric load ring. A wear-resistant annular plate is bonded to one of the members of the joint. The load ring is compressed when mounted in place, thus urging the seal ring in sealing contact with the wear-resistant annular plate.

There is a continued need in the art to provide additional solutions for a seal assembly. For example, there is a continued need for a seal assembly which can maintain adequate seal pressure over an extended useful life of the seal assembly.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a track pin joint assembly that includes a pin, a first link, a second link, and a seal assembly. The pin defines a longitudinal axis. The first link and the second link each define a pin passage receiving the pin therein. The first link is pivotable about the longitudinal axis with respect to the second link. The first link includes a load ring engagement surface defining, at least in part, a seal cavity disposed in proximal relationship to the second link.

The seal assembly is disposed in the seal cavity and is sealingly disposed between the first link and the second link. The seal assembly includes a seal ring, a load ring, and a seal lip.

The seal ring is annular. The seal ring has an axial flange extending along the longitudinal axis and a radial flange extending along a radial plane perpendicular to the longitudinal axis.

The load ring is annular and includes a seal ring engagement surface and a first link engagement surface. The seal ring engagement surface includes an axial segment and a radial segment in engaging relationship with the axial flange and the radial flange of the seal ring, respectively. The first link engagement surface is in engaging relationship with the load ring engagement surface of the first link. The seal lip is annular and is connected to the second link such that the seal lip circumscribes the pin passage and extends axially from the second link toward the seal ring. The seal lip is in sealing contact with the radial flange of the seal ring.

In another embodiment, a track link for a track assembly is disclosed that includes a body and a seal lip. The body includes a first end, a second end, an outer sidewall, and an inner sidewall. The outer sidewall and the inner sidewall extend along a body axis between the first end and the second end. The first end and the second end define a first pin passage and a second pin passage, respectively. The first pin passage and the second pin passage each extends between the outer sidewall and the inner sidewall. The seal lip is annular and is connected to the body such that the seal lip circumscribes the first pin passage and extends from the outer sidewall of the body.

In yet another embodiment, a method for sealing a track joint is provided. The method includes inserting a pin into a pin passage defined in each of a first link and a second link. The pin defines a longitudinal axis. The first link is pivotable about the longitudinal axis with respect to the second link. The first link includes a load ring engagement surface defining, at least in part, a seal cavity disposed in proximal relationship to the second link.

A seal ring is mounted about the pin such that the seal ring is in circumscribing relationship to the pin. The seal ring is disposed within the seal cavity. A load ring is mounted about the seal ring such that the load ring is in circumscribing relationship to the seal ring. The load ring is in sealing relationship with the load ring engagement surface of the first link. A seal lip is connected to the second link such that the seal lip extends axially from the second link toward the seal ring and is in sealing contact with a radial flange of the seal ring.

Further and alternative aspects and features of the disclosed principles will be appreciated from the following detailed description and the accompanying drawings. As will be appreciated, the principles related to track seal assemblies disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a diagrammatic side elevational view of an embodiment of a track-type machine which includes an undercarriage constructed in accordance with principles of the present disclosure.

FIG. 2 is a perspective view of a portion of an embodiment of a track chain assembly constructed in accordance with principles of the present disclosure.

FIG. 3 is a transverse cross-sectional view of an embodiment of a track pin joint assembly of the track chain assembly of FIG. 2.

FIG. 4 is an enlarged, detail view taken from FIG. 3, illustrating a seal assembly constructed in accordance with principles of the present disclosure shown in an installed and compressed condition in a seal cavity of a first link such that the seal assembly is in sealing engagement with the first link and a seal lip is connected to a second link to provide a running seal therebetween.

FIG. 5 is an enlarged, detail view taken from FIG. 4, as indicated by circle V in FIG. 4, but illustrating a link in a partially installed position such that the seal assembly is shown in an uncompressed state.

FIG. 6 is a view as in FIG. 5 of another embodiment of a seal assembly constructed in accordance with principles of the present disclosure, illustrating a link in a partially installed position such that the seal assembly is shown in an uncompressed state.

FIG. 7 is a view as in FIG. 5 of another embodiment of a seal assembly constructed in accordance with principles of the present disclosure, illustrating a link in a partially installed position such that the seal assembly is shown in an uncompressed state.

FIG. 8 is a flowchart illustrating steps of an embodiment of a method for sealing a track joint following principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

The present disclosure provides a seal assembly for a track chain pin joint assembly of an undercarriage of a track-type machine. Examples of track-type machines include machines used for construction, mining, forestry, and other similar industries. In some embodiments, the machine can be a dozer, loader, excavator, or any other on-highway or off-highway vehicle having a track-type undercarriage. The undercarriage can include track assemblies adapted to engage the ground, or other surface, to propel the track-type machine.

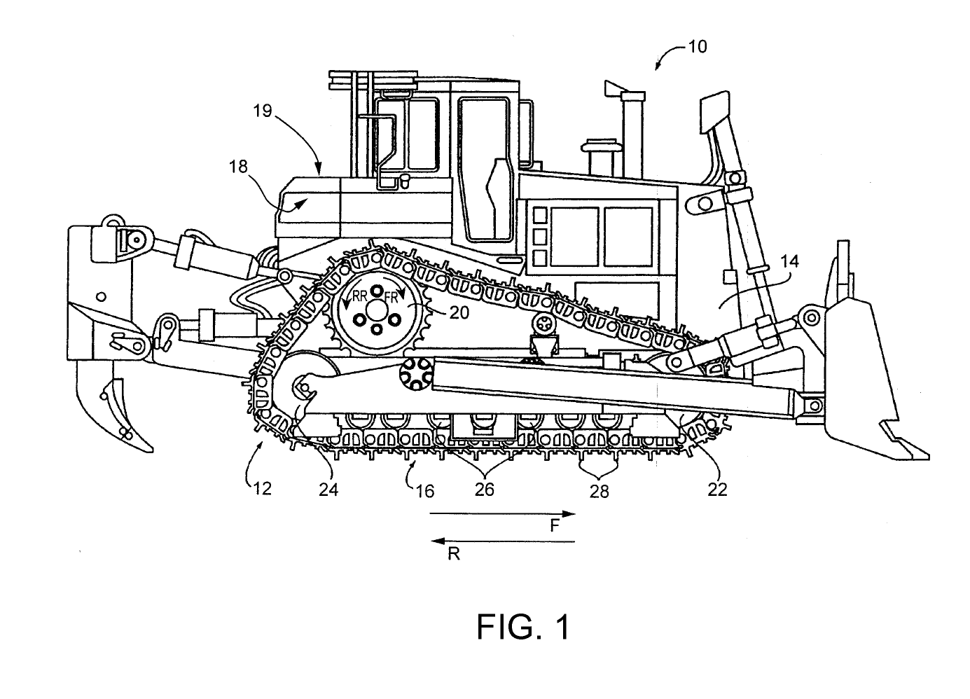

Turning now to the Figures, there is shown in FIG. 1 an exemplary embodiment of a machine 10 with a track-type undercarriage 12. The machine 10 may also be referenced herein as a track-type machine. In other embodiments, the machine 10 may be any suitable machine with a track-type undercarriage, such as, a dozer, loader, excavator, or any other on-highway or off-highway vehicle.

The machine 10 includes a frame 14 having a first track chain assembly 16 disposed on a first side 18 thereof, and a second track chain assembly (not shown) disposed on a second side 19 thereof. The second side 19 is in opposing relationship to the first side 18. Together, the track assemblies are adapted to engage the ground, or other surface, to propel the machine 10.

It should be appreciated that the track assemblies of the machine 10 may be similar and, further, may represent mirror images of one another. As such, only the first track chain assembly 16 will be described herein. It should be understood that the description of the first track chain assembly 16 is applicable to the second track chain assembly, as well.

The first track chain assembly 16 extends about a plurality of rolling elements such as a drive sprocket 20, a front idler 22, a rear idler 24, and a plurality of track rollers 26. The track chain assembly 16 includes a plurality of ground-engaging track shoes 28 for engaging the ground, or other surface, and propelling the machine 10.

During typical operation of the undercarriage 12, the drive sprocket 20 is driven in a forward rotational direction FR to drive the track chain assembly 16, and thus the machine 10, in a forward direction F, and in a reverse rotational direction RR to drive the track chain assembly 16, and thus the machine 10, in a reverse direction R. The drive sprockets 20 of the undercarriage 12 can be independently operated to turn the machine 10.

While the machine 10 is illustrated in the context of a track-type machine, it should be appreciated that the present disclosure is not thereby limited, and that a wide variety of other machines having tracks are also contemplated within the present context. For example, in other embodiments, the track chain assembly 16 can be included in a conveyor system, as a track for transmitting torque between rotating elements, or in any other application known to those skilled in the art.

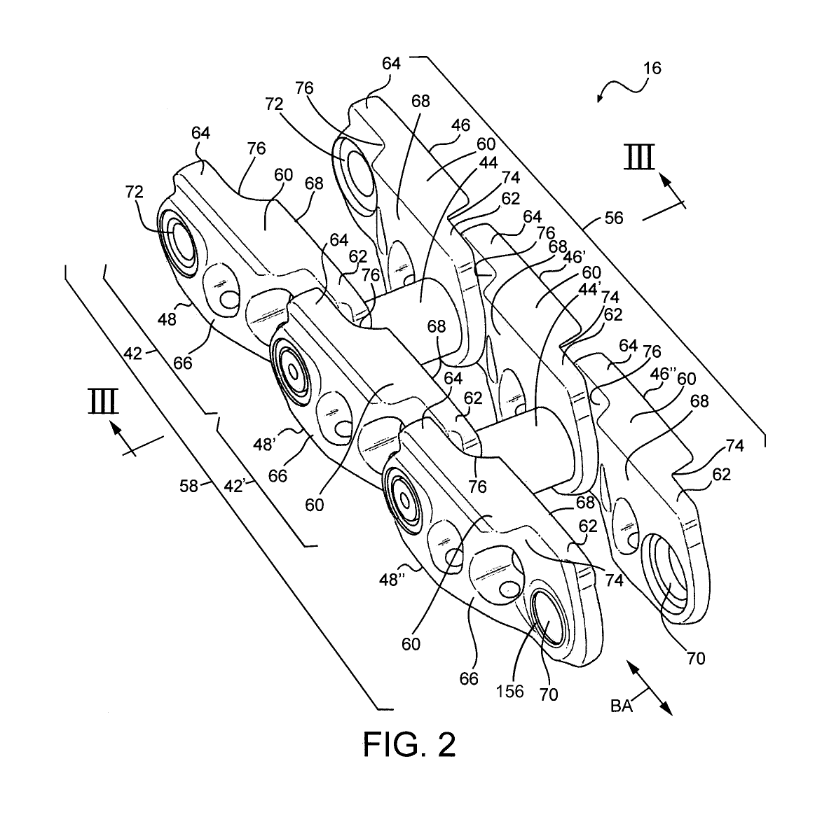

Referring now to FIG. 2, the first track chain assembly 16, only a portion of which is shown, includes a plurality of track pin joint assemblies 42. Each track pin joint assembly 42 includes a pin assembly 44, an inboard link 46, an outboard link 48, and a track shoe 28 (see FIG. 1) connected to the inboard and outboard links 46, 48.

A number of track pin joint assemblies 42 are mechanically coupled to adjacent track pin joint assemblies 42 so that, when an appropriate number of these track pin joint assemblies 42 are connected together, the track chain assembly 16 is formed. The first track chain assembly 16 has a predetermined length for a given application with opposite ends that are capable of being connected together to form a closed loop. The closed loop is formed by mechanically coupling the opposite ends together to respectively provide an inboard chain 56 of a series of inboard links 46 and an outboard chain 58 of a series of outboard links 48 coupled together via a plurality of pin assemblies 44. The inboard links 46 and the outboard links 48 can be made from any suitable material, such as, metal, for example.

It should be recognized that the terms “inner” and “outer,” in reference to the links 46, 48 of each track pin joint assembly 42 in this example are used merely as descriptors for the orientation shown in the Figures. Other terms, such as, “left” and “right” or “first” and “second,” could be interchangeably used as well. It should be understood that these terms are merely convenient labels applied to the different views and are not meant to be limiting in any way.

The inboard links 46 and the outboard links 48 are mirror images of each other. Accordingly, it should be understood that the description of one link 46 is generally applicable to the other link, as well. The inboard link 46 and the outboard link 48 each includes a body 60 having a first end 62, a second end 64, an outer sidewall or exterior surface 66 and an inner sidewall or interior surface 68. The outer sidewall 66 and the inner sidewall 68 extend along a body axis BA between the first end 62 and the second end 64. The first end 62 and the second end 64 defining a first pin passage 70 and a second pin passage 72, respectively. Each of the first pin passage 70 and the second pin passage 72 extends between the outer sidewall 66 and the inner sidewall 68.

The illustrated inboard and outboard links 46, 48 comprise offset links. The first ends 62 of the inboard and outboard links 46, 48 comprise inwardly offset ends, and the second ends 64 of the inboard and outboard links 46, 48 comprise outwardly offset ends. In the illustrated embodiment, the outer sidewall 66 of the body 60 defines a first offset recess 74 at the first end 62 of the body 60, and the inner sidewall 68 of the body 60 defines a second offset recess 76 at the second end 64 of the body 60. The inwardly offset ends 62 of the inboard link 46 and the outboard link 48 of each track pin joint assembly 42 can be rotatably mounted to the pin assembly 44 thereof. The outwardly offset ends 64 of the inboard link 46 and the outboard link 48 of each track pin joint assembly 42 can be fixedly coupled to the pin assembly 44′ of an adjacent track pin joint assembly 42′. In other embodiments, the links 46, 48 of the track chain assembly 16 can have a different configuration, as one skilled in the art would recognize.

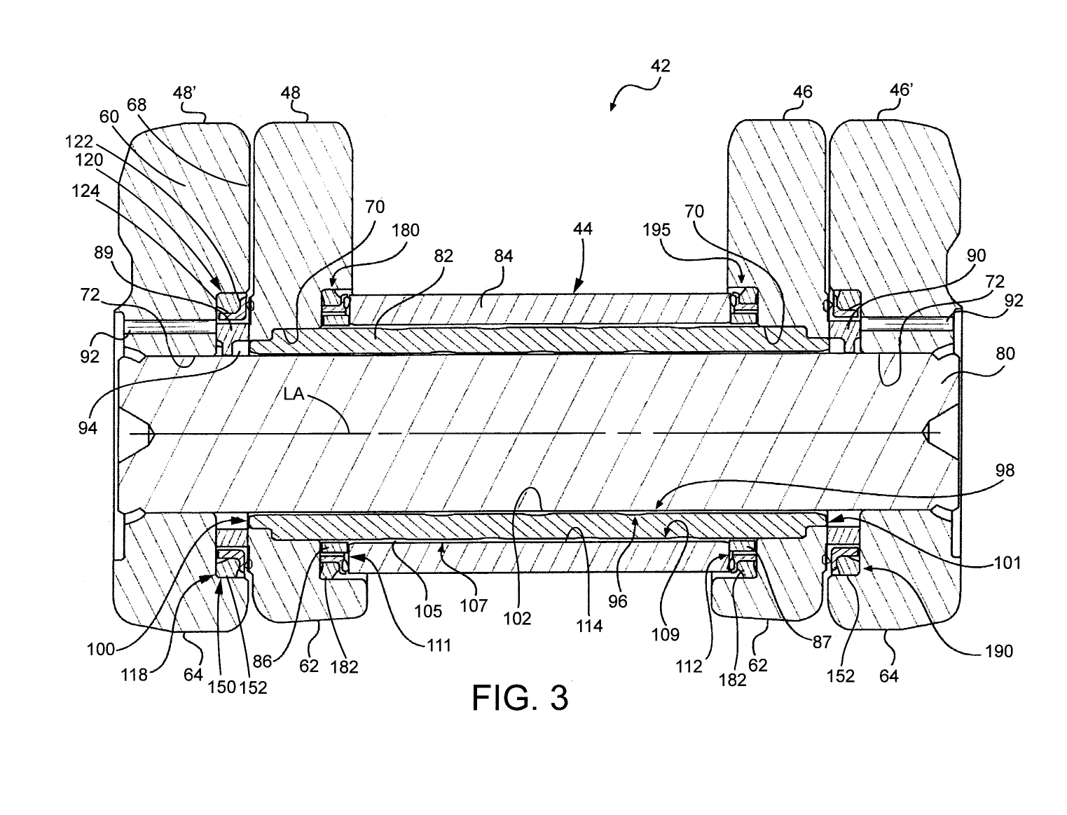

Referring to FIG. 3, the pin assembly 44 is illustrated according to one of several possible embodiments of the present disclosure. The illustrated pin assembly 44 includes a pin 80, a bushing 82 which is an inner bushing in this embodiment, an outer bushing 84, a pair of bushing thrust rings 86, 87, and a pair of link thrust rings 89, 90.

The pin 80 defines a longitudinal axis LA. The pin 80 extends through the first pin passage 70 of the inboard and the outboard links 46, 48 of the track pin joint assembly 42 and is positioned at least partially in the second pin passage 72 of the inboard and the outboard links 46′, 48′ of the adjacent track pin joint assembly 42′.

In other embodiments, the pin 80 can have a different configuration. For example, the track pin can include an inner surface that defines a cylindrical bore extending therethrough along the longitudinal axis LA and concentrically disposed about the longitudinal axis LA and at least one cross bore that extends from the outer surface thereof inwardly to the bore in a direction perpendicular to the central longitudinal axis LA for distributing lubricant stored in the central bore of the pin.

The bushing 82 is positioned coaxially around the pin 80 and is rotatable about the longitudinal axis LA relative to the pin 80. As shown, the inwardly offset ends 62 of the inboard and the outboard links 46, 48 are fixedly connected to the bushing 82, which can be at least partially positioned within the first pin passage 70 of the inwardly offset ends 62 of the inboard and the outboard links 46, 48. Similarly, the outwardly offset ends 64 of the inboard and the outboard links 46′, 48′ of the adjacent track pin joint assembly 42′ are secured to the pin 80, which can be at least partially positioned within the second pin passage 72 of the inboard and the outboard links 46′, 48′ of the adjacent track pin joint assembly 42′.

For example, the bushing 82 and the pin 80 can be secured to the respective inboard and the outboard links 46, 48; 46′, 48′ by way of press-fits. Specifically, the bushing 82 can be press-fit into the first pin passage 70 of the inwardly offset ends 62 of the inboard and outboard links 46, 48, and the pin 80 can be press-fit into the second pin passage 72 of the inboard and outboard links 46′, 48′ of the adjacent track pin joint assembly 42′. In other embodiments, any suitable technique for securing the components together can be used, such as, by using welds, snap rings, or other mechanisms known in the art.

Accordingly, the inwardly offset ends 62 mounted to the bushing 82 can pivot relative to the outwardly offset ends 64 mounted to the pin 80 as the track pin joint assembly 42 rotates. In order to facilitate such rotation, one or both of the bushing 82 and the pin 80 can be coated with a friction-reducing material, such as, a diamond-like carbon or electroless nickel, for example, or can be carburized, nitrided, or polished to reduce friction between the bushing 82 and the pin 80.

In embodiments, a lubricant can be deposited between the bushing 82 and the pin 80. The lubricant can be added via passages 92 defined in the second ends 64 of the inboard and outboard links 46′, 48′ of the adjacent track pin joint assembly 42′. The lubricant can flow through the passages 92 and be contained in a link lubricant cavity 94 at least partially defined by an inner surface 96 of the inner bushing 82 which is generally cylindrical and an outer surface 98 of the pin 80 which also is generally cylindrical. In embodiments, the link lubricant cavity 94 can extend into and be at least partially defined by the link thrust rings 89, 90 respectively positioned at first and second axial end faces 100, 101 of the inner bushing 82.

The inner surface 96 of the bushing 82 defines a passage in the form of a cylindrical bore 102 therethrough that is concentrically disposed about the longitudinal axis LA. The bushing 82 is disposed concentrically about the pin 80 with the pin 80 extending through the cylindrical bore 102 of the bushing 82. The first and second axial end faces 100, 101 of the inner bushing 82 are respectively disposed adjacent to the second ends 64 of the outboard and inboard links 48′, 46′ of the adjacent track pin joint assembly 42′, respectively.

The illustrated embodiment includes the outer bushing 84. The outer bushing 84 is positioned coaxially around the inner bushing 82 and is configured to engage the drive sprocket 20 that propels the first track chain assembly 16. The outer bushing 84 can rotate about the longitudinal axis LA relative to inner bushing 82 when it engages the drive sprocket 20, thereby reducing wear on the outer bushing 84 caused by the interaction between the outer bushing 84 and the drive sprocket 20. In embodiments, a friction-reducing coating can be applied to one or both of the outer bushing 84 and the inner bushing 82, such as diamond-like carbon or electroless nickel, for example, or the friction between the components can be reduced by carburizing, nitriding, or polishing one or both of the contacting surfaces of the outer bushing 84 and the inner bushing 82. In embodiments, a lubricant can be deposited between the outer bushing 84 and the inner bushing 82. This lubricant can be the same as or different from the lubricant deposited between the inner bushing 82 and the pin 80.

The lubricant can be added during the assembly of the track pin joint assembly 42, and can be contained in a bushing lubricant cavity 105 at least partially defined by an inner surface 107 of the outer bushing 84 which is generally cylindrical and an outer surface 109 of the inner bushing 82 which is also generally cylindrical. In embodiments, the bushing lubricant cavity 105 can be isolated from the link lubricant cavity 94 so that a leak in the bushing lubricant cavity 105 does not affect the link lubricant cavity 94 (and vice versa). In embodiments, the bushing lubricant cavity 105 can extend into and be at least partially defined by the bushing thrust rings 86, 87 respectively positioned at first and second axial end faces 111, 112 of the outer bushing 84 and coaxially around the inner bushing 82 and the pin 80.

The inner surface 107 of the outer bushing 84 defines a passage in the form of a cylindrical bore 114 therethrough that is concentrically disposed about the longitudinal axis LA. The outer bushing 84 is disposed concentrically about the inner bushing 82 and the pin 80 with the pin 80 and the inner bushing 82 extending through the cylindrical bore 114 of the outer bushing 84. The first and second axial end faces 111, 112 of the outer bushing 84 are respectively disposed adjacent to the first ends 62 of the outboard and inboard links 48, 46 of the track pin joint assembly 42.

In other embodiments, one or more different bushings can be used in the track pin joint assembly 42. For example, in embodiments, the outer surface 109 of the bushing 82 can define a lobed surface, such as is shown and described in U.S. Patent Application Publication No. 2010/0139993 for a “Lobed Bushing For Track Assembly and Track-Type Machine Using Same,” which is incorporated in its entirety herein by this reference. In yet other embodiments, the bushing 82 can have a different shape and configuration as known in the art. In yet other embodiments, the track pin joint assembly 42 can include an inner and an outer bushing which have a different shape and configuration as known in the art.

The components of the track pin joint assembly 42 can define a plurality of annular seal grooves or cavities that are concentrically disposed about the longitudinal axis LA of the pin 80. Each seal cavity can be adapted to house therein a seal assembly suitable for sealingly engaging relatively rotatable components of the track pin joint assembly 42, including seal assemblies constructed in accordance with principles of the present disclosure.

For example, the inner sidewall 68 of the body 60 of the outboard link 48′ defines a seal cavity 118 in the form of an annular counterbore that circumscribes the second pin passage 72 at the second end 64 of the body 60 of the outboard link 48′. The inner sidewall 68 of the body 60 of the outboard link 48′ includes a load ring engagement surface 120 defining, at least in part, the axially-extending seal cavity 118. The seal cavity 118 is positioned in the second end 64 of the body 60 of the outboard link 48′ such that seal cavity 118 is concentric with the central longitudinal axis LA of the pin 80.

In embodiments, the load ring engagement surface 120 can include at least part of a cylindrical axial wall segment 122 and/or a radial base segment 124. The cylindrical axial wall segment 122 and the radial base segment 124 define the seal cavity 118. The cylindrical axial wall segment 122 is concentrically disposed about the longitudinal axis LA of the pin 80. In the illustrated embodiment, the load ring engagement surface 120 includes at least part of the cylindrical axial wall segment 122 and the radial base segment 124.

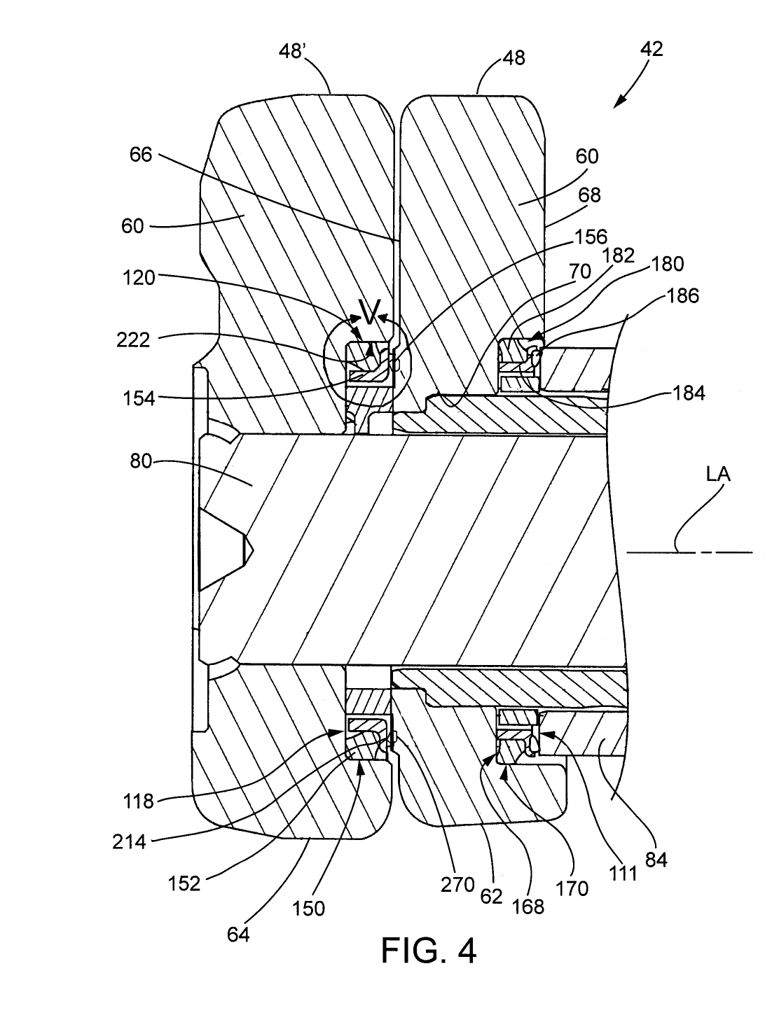

Referring to FIG. 4, a first seal assembly 150 constructed in accordance with principles of the present disclosure can be disposed within the seal cavity 118 defined in part by the load ring engagement surface 120 at the second end 64 of the body 60 of the outboard link 48′ of the adjacent track pin joint assembly 42′, which can be considered a “first link.” The axially-extending seal cavity 118 is disposed in proximal relationship to the first end 62 of the body 60 of the outboard link 48 of the track pin joint assembly 42, which can be considered a “second link” in this example. The seal assembly 150 sealingly engages the first link in the form of the outboard link 48′ of the adjacent track pin joint assembly 42′ and the second link in the form of the outboard link 48 of the track pin joint assembly 42 while allowing relative rotation therebetween.

The first seal assembly 150 includes a load ring 152, a can or seal ring 154, and a seal member in the form of a seal lip 156. The load ring 152, the seal ring 154, and the seal lip 156 are all annular. The load ring 152 can be made from any suitable material which can provide sealing and spring-like characteristics, such as an elastomeric material, for example. In embodiments, the load ring 152 can be made from a suitably abrasion-resistant rubber. The seal lip 156 can be made from any suitable sealing material, such as, a plastic including a urethane compound, for example. The seal ring 154 can be made from any suitable material, such as metal or ceramic. In embodiments, the seal ring 154 can be made from a corrosion- and abrasion-resistant material, such as metal or ceramic, for example. The components of the seal assembly 150 can be made from other materials in other embodiments without altering the functional aspects of the design.

The load ring 152 sealingly engages the load ring engagement surface 120 of the outboard link 48′ of the adjacent track pin joint assembly 42′, which can be considered a first link in this instance. The load ring 152 is circumferentially mounted to the seal ring 154. The seal lip 156 is connected to the outboard link 48 of the track pin joint assembly 42, which can be considered a second link in this instance, such that the seal lip 156 circumscribes the first pin passage 70 and extends axially from the second link (in the form of the outboard link 48 in this instance) toward the seal ring 154.

The load ring 152 and the seal ring 154 are positioned in the seal cavity 118 so that the load ring 152 acts upon the seal ring 154 to urge the seal ring 154 in an axial direction along the longitudinal axis LA from the seal cavity 118 into sealing engagement with the seal lip 156. The seal lip 156 can rotate with respect to the seal ring 154 against which it is sealingly engaged to provide a running seal therebetween.

The second link in the form of the outboard link 48 of the track pin joint assembly 42 also defines an axially-extending seal cavity 168 in the form of an annular channel or groove. The inner sidewall 68 of the body 60 of the outboard link 48 includes a load ring engagement surface 170 defining, at least in part, the axially-extending seal cavity 168. The seal cavity 168 is positioned in the first end of the outboard link 48 such that seal cavity 168 is concentric with the longitudinal axis LA. The axially-extending seal cavity 168 is disposed in proximal relationship to the first axial end face 111 of the outer bushing 84 of the track pin joint assembly 42. The seal cavity 168 at the first end 62 of the outboard link 48 can be similar in configuration to the seal cavity 118 at the second end 64 of the outboard link 48′ of the adjacent track pin joint assembly 42′.

A second seal assembly 180 is disposed in the seal cavity 168 at the first end 62 of the outboard link 48. The second seal assembly 180 sealingly engages a first member in the form of the outboard link 48 and a second member in the form of the outer bushing 84 while allowing relative rotation therebetween about a rotational axis that coincides with the longitudinal axis LA of the pin 80.

The second seal assembly 180 includes a load ring 182, a seal ring 184, and a seal member in the form of a seal lip 186. The seal lip 186 is connected to the seal ring 184. The load ring 182 and the seal lip 186 of the second seal assembly 180 are positioned in seal cavity 168 so that the load ring 182 acts upon the seal ring 184 to urge the seal lip 186 in an axial direction along the longitudinal axis LA from the seal cavity 168 into sealing engagement with the first axial end face 111 of the outer bushing 84, which can be considered a second member in this instance. The seal lip 186 can rotate with respect to the sealing surface of the first axial end face 111 of the outer bushing 84 against which it is sealingly engaged to provide a running seal therebetween. The load ring 182 sealingly engages the load ring engagement surface 170 of the outboard link 48, which can be considered a first member in this instance. The components of the second seal assembly 180 can be similar in composition and function to that of the first seal assembly 150 as described above in other respects.

Referring back to FIG. 3, in the illustrated embodiment, the inboard links 46′, 46 also contain third and fourth seal assemblies 190, 195 which are substantially the same as the first seal assembly 150 and the second seal assembly 180, respectively. The outboard and inboard links 48, 46 of the track pin joint assembly 42 can be coupled to the inner bushing 82 such that the second and fourth seal assemblies 180, 195 are compressively engaged between the respective adjacent components to sealingly contact the sealing surfaces of the adjacent members such that a running fluid-tight seal is formed therebetween. In a similar manner, the outboard and inboard links 48′, 46′ of the adjacent track pin joint assembly 42′ can be coupled to the pin 80 such that the first and third seal assemblies 150, 190 are compressively engaged between the respective adjacent links 48′, 48; 46′, 46 to sealingly contact the sealing surfaces of the adjacent members such that a running fluid-tight seal is formed therebetween. As shown, each load ring 152, 182 sealingly engages the link with which it is associated and is placed in compression. The compression of the load rings 152, 182 provides a sealing force to each corresponding seal lip 156, 186, which is sealingly engaged against the sealing surface of the seal ring 154 and the outer bushing 84, respectively, to form a running fluid-tight seal therebetween.

The link thrust rings 89, 90 are configured to transmit axial load between adjacent links 48′, 48; 46, 46′, and can be adapted to limit the axial load placed on the first and third seal assemblies 150, 190, respectively. The first and third seal assemblies 150, 190 are positioned radially outward of the link thrust rings 89, 90, respectively, and provide a running seal between the adjacent links 48′, 48; 46, 46′, respectively, to retain lubricant in the link lubricant cavity 94.

The bushing thrust rings 86, 87 can be adapted to limit the axial load placed on the second and fourth seal assemblies 180, 195, respectively. The second and fourth seal assemblies 180, 195 are positioned radially outward of the bushing thrust rings 86, 87, respectively, and provide a running seal between the outboard and inboard links 48, 46 and the outer bushing 84 to retain lubricant in the bushing lubricant cavity 105.

The use of the terms “first link,” “second link,” “first member,” “second member,” and the like are for illustration purposes and are merely convenient labels applied to illustrative pairs of relatively rotatable components to describe various principles of the present disclosure. These phrases should not be viewed as limiting in any way.

Although the pin assembly 44 shown in FIG. 4 has a seal cavity 118 positioned in the second ends 64 of the inboard and outboard links 46′, 48′ of the adjacent track pin joint assembly 42′ and a seal cavity 168 positioned in the first ends 62 of the inboard and outboard links 46, 48 of the track pin joint assembly 42, it is also contemplated that the seal cavities 118, 168 are located in other positions in other embodiments. Accordingly, in other embodiments of a track pin joint assembly, other components (such as, the bushing 84, for example) can define suitable seal cavities, and other seal cavity locations within the components of the track pin joint assembly 42 (such as the outer sidewall 66 of the inboard and outboard links 46, 48, for example) can be used.

In other embodiments, a track pin joint assembly according to principles of the present disclosure can include other components and have different arrangements. For example, in other embodiments the track pin joint assembly can include a pin cartridge assembly with sleeve bearings and other components as shown and described in U.S. Patent Application Publication No. 2006/0284485, which is incorporated in its entirety herein by this reference.

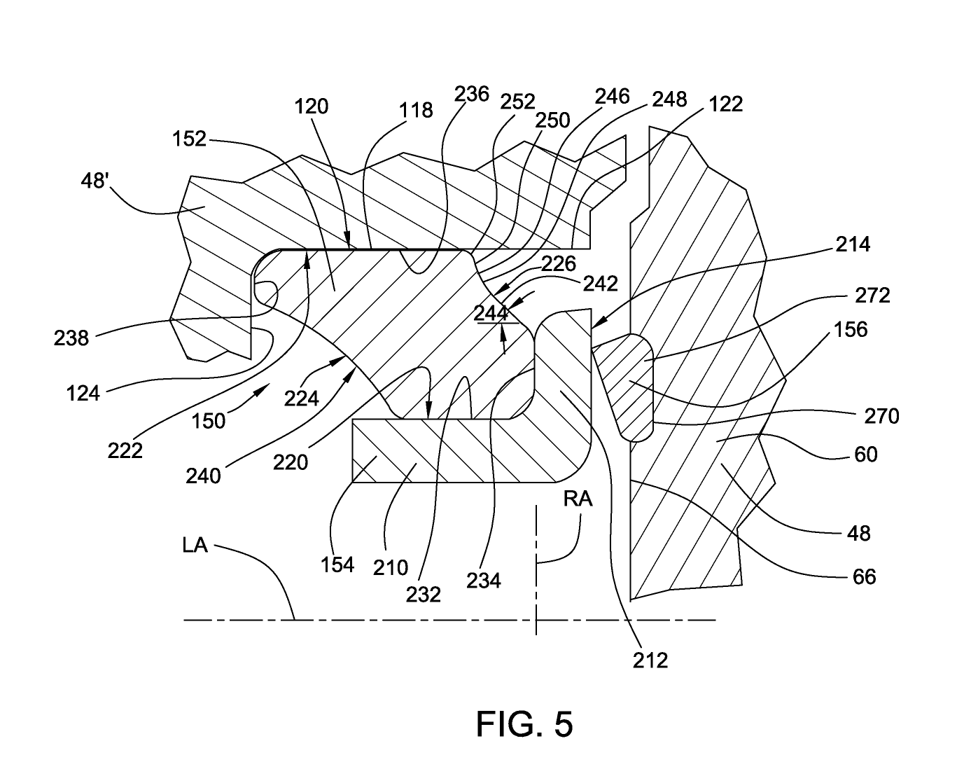

Referring to FIG. 5, the first seal assembly 150, which is constructed in accordance with principles of the present disclosure, is shown in an uninstalled state wherein the components are not compressed. The components of the first seal assembly 150 are in the shape of an annular ring. The cross-sectional shapes of the components of the first seal assembly 150 through a plane extending along the rotational axis and intersecting the radial center of the seal assembly 150 are shown. It should be understood that the illustrated components have a substantially similar configuration about their entire circumference such that a cross-sectional view taken through another plane extending along the rotational axis and intersecting the radial center of the seal assembly 150 is substantially similar.

The first seal assembly 150 includes the load ring 152, the can or seal ring 154, and the seal lip 156, which is connected to the second link, in the form of the outboard link 48, and which extends axially therefrom toward the seal ring 154. Inasmuch as the third seal assembly 190 is identical to the first seal assembly 150, it will be understood that the description of the first seal assembly 150 is also applicable to the third seal assembly 190.

The first seal assembly 150 is adapted for use in sealing a track pin joint having a first link pivotable about a rotational axis relative to a second link, such as, the outboard link 48′ of the adjacent track pin joint assembly 42′ being pivotable relative to the outboard link 48 about a rotational axis that coincides with the longitudinal axis LA of the pin 80, for example. The first link in the form of the outboard link 48′ of the adjacent track pin joint assembly 42′ and the second link in the form of the outboard link 48 are both coaxial with the pin 80 about the longitudinal axis LA. The first link in the form of the outboard link 48′ of the adjacent track pin joint assembly 42′ includes the load ring engagement surface 120 that defines, at least in part, the axially-extending seal cavity 118 about the rotational axis LA which is disposed in proximal relationship to the second link in the form of the outboard link 48. The first seal assembly 150 can be disposed within the seal cavity 118 to sealingly engage the first link (the outboard link 48′ in this instance) and the second link (the outboard link 48 in this example) while allowing relative rotation therebetween.

The load ring engagement surface 120 of FIG. 5 has a generally straight profile to define a cylinder with a flat radial base. In other embodiments, the load ring engagement surface 120 can have a different shape. The load ring engagement surface 120 of the first link (the outboard link 48′ in this instance) sealingly engages the load ring 152.

The seal ring 154 is in the form of an annulus. The seal ring 154 has an axial flange 210, extending along the rotational or longitudinal axis LA, and a radial flange 212, extending along a radial axis RA, which is perpendicular to the rotational axis LA. The radial flange 212 of the seal ring 154 includes a sealing surface 214 in sealing engagement with the seal lip 156 of the seal assembly 150.

The load ring 152 is in the form of an annulus. The load ring 152 includes a seal ring engagement surface 220, a first link engagement surface 222, an inner relief surface 224, and an outer relief surface 226.

The seal ring engagement surface 220 is adapted to engage the seal ring 154. The seal ring engagement surface 220 includes an axial segment 232 and a radial segment 234 adapted to engage the axial flange 210 and the radial flange 212 of the seal ring 154, respectively. The axial segment 232 of the seal ring engagement surface 220 is in proximate relationship with the axial flange 210 of the seal ring 154, and the radial segment 234 is in proximate relationship with the radial flange 212 of the seal ring 154. In some embodiments, and as shown, the axial segment 232 of the seal ring engagement surface 220 extends in substantially parallel relationship to the longitudinal axis LA of the pin 80 with the radial segment 234 extending at an angle to the axial segment 232. In embodiments, the angle can be in a range between about twenty degrees and about one hundred sixty degrees.

As shown, the axial segment 232 and the radial segment 234 of the seal ring engagement surface 220 are disposed in substantially perpendicular relationship with respect to each other. The illustrated axial segment 232 of the seal ring engagement surface 220 is substantially cylindrical and substantially parallel to the longitudinal axis LA of the pin 80. The illustrated radial segment 234 is substantially perpendicular to the longitudinal axis LA of the pin 80 and extends along a radial plane RA perpendicular to the longitudinal axis LA.

The first link engagement surface 222 is disposed opposite the seal ring engagement surface 220 and includes an axial segment 236 and a radial segment 238. The first link engagement surface 222 is adapted to sealingly engage the load ring engagement surface 120 of the first link in the form of the outboard link 48′ of the adjacent track pin assembly 42′ in the illustrated example of FIG. 5.

As shown, the axial segment 236 of the first link engagement surface 222 is substantially cylindrical and substantially parallel to the longitudinal axis LA of the pin 80. The illustrated axial segment 236 of the first link engagement surface 222 is substantially parallel to the axial segment 232 of the seal ring engagement surface 220. In other embodiments, the axial segment 236 of the first link engagement surface 222 can have a substantially frusto-conical shape, being disposed in oblique relationship to the axial segment 232 of the seal ring engagement surface 220 and to the longitudinal axis LA of the pin 80 when installed about the pin 80 in a track pin joint assembly.

The radial segment 238 of the first link engagement surface 222 can be shaped to engage a portion of the base surface 204 in the seal cavity 118. The radial segment 238 of the first link engagement surface 222 is in distal relationship with the radial segment 234 of the seal ring engagement surface 220. In some embodiments, the radial segment 238 of the first link engagement surface 222 can include a straight portion. In other embodiments, the radial segment 238 of the first link engagement surface 222 has a rounded convex shape.

In embodiments, and as shown, the radial segment 238 of the first link engagement surface 222 can be in outward radial, offset relationship with the radial segment 234 of the seal ring engagement surface 220. The illustrated radial segment 238 of the first link engagement surface 222 is in outward, non-overlapping radial relationship with the illustrated radial segment 234 of the seal ring engagement surface 220.

The inner relief surface 224 extends between the radial segment 238 of the first link engagement surface 222 and the axial segment 232 of the seal ring engagement surface 220. The illustrated inner relief surface 224 is in the form of a concave curved surface when in an uninstalled, uncompressed condition, as shown in FIG. 5.

The inner relief surface 224 can be configured to define an inner relief area 240 in the seal cavity 118 adjacent the radial base segment 124 of the first link in the form of the outboard link 48′ of the adjacent track pin joint assembly 42′. In embodiments, the inner relief surface 224 can be configured to allow the load ring 152 to deform when under axial load to help prevent undergoing excessive twist which could lead to loss in contact pressure and seal failure.

The outer relief surface 226 extends between the axial segment 236 of the first link engagement surface 222 and the radial segment 234 of the seal ring engagement surface 220. The illustrated outer relief surface 226 includes an inclined segment 242 which is disposed at an oblique angle 244 with respect to the axial segment 232 of the seal ring engagement surface 220 and the rotational axis LA. The inclined segment 242 of the outer relief surface 226 is adjacent the radial segment 234 of the seal ring engagement surface 220. In embodiments, the angle 244 of the inclined segment 242 of the outer relief surface 226 with respect to the axial segment 232 of the seal ring engagement surface 220 can be in a range from about twenty degrees to about sixty degrees. The illustrated angle 244 between the inclined segment 242 of the outer relief surface 226 and the axial segment 232 of the seal ring engagement surface 220 is about forty degrees.

The outer relief surface 226 includes a reverse curve portion 246 adjacent the axial segment 236 of the first link engagement surface 222. The reverse curve portion 246 of the outer relief surface 226 includes a concave segment 248, a transition segment 250, and a convex segment 252.

The concave segment 248 of the outer relief surface 226 is disposed adjacent the inclined segment 242 of the outer relief surface 226. The convex segment 252 of the outer relief surface 226 is disposed adjacent the axial segment 236 of the first link engagement surface 222. The transition segment 250 of the outer relief surface 226 is disposed between the concave segment 248 and the convex segment 252 of the outer relief surface 226.

The outer relief surface 226 can be configured to define an outer relief area 255 in the seal cavity 118 adjacent the cylindrical axial wall segment 122 of the first link in the form of the outboard link 48′ of the adjacent track pin joint assembly 42′ and a distal end 257 of the radial flange 212 of the seal ring 154. In embodiments, the outer relief surface 226 can be configured to allow the load ring 152 to deform when under axial load while inhibiting the load ring 152 from becoming pinched between the cylindrical axial wall segment 122 and the distal end 257 of the seal ring 154 to help prevent undergoing excessive twist which could lead to loss in contact pressure and seal failure.

When the seal assembly 150 is installed in the seal cavity 118 and under compression, such as when the second link in the form of the outboard link 48 moves axially along the longitudinal axis LA relative to the first link in the form of the outboard link 48′ of the adjacent track pin joint assembly 42′ to decrease the axial length of the seal cavity 118 along the longitudinal axis LA, the load ring 152 can deform in response to the forces exerted against it. The inner relief area 240 and the outer relief area 255 can provide a space into which the load ring 152 can deform, even under conditions in which the seal cavity 118 has a decreased volume.

Referring to FIGS. 4 and 5, the seal lip 156 is connected to the body 60 of the outboard link 48 such that the seal lip 156 circumscribes the first pin passage 70 of the outboard link 48 and extends from the outer sidewall 66 of the body 60. The seal lip 156 extends axially from the second link (in the form of the outboard link 48 in the illustrated example of FIG. 5) such that it is in engaging relationship with the sealing surface 214 of the radial flange 212 of the seal ring 154 to provide a running seal therebetween.

The seal lip 156 can be connected to the body 60 of the link 48 using any suitable technique. For example, in embodiments, the seal lip can be molded to the link 48. In some embodiments, the seal lip 156 is separately formed and then attached to the link 48. For example, in some of such embodiments, the seal lip 156 can be connected to the body 60 of the link 48 using a suitable adhesive.

In embodiments, the second link 48 includes an exterior surface 66 that defines an annular groove 270 circumscribing the pin passage 70 of the second link, and the seal lip 156 is disposed within the annular groove 270 thereof. In the illustrated embodiment, the outer sidewall 66 of the body 60 of the outboard link 48 defines the annular groove 270. The seal lip 156 is disposed within the annular groove 270 and a base segment 272 of the seal lip is connected to the second link 48. In embodiments, the seal lip 156 can be positioned within the annular groove 270 and mounted to the second link 48 using any suitable technique, such as insert molding or by connecting the seal lip with an adhesive, for example.

Referring to FIG. 4, the seal assembly 150 is installed in the seal cavity 118. The first link in the form of the outboard link 48′ of the adjacent track pin joint assembly 42′ and the second link in the form of the outboard link 48 are both coaxial with the pin 80 about the longitudinal axis LA. The first link 48′ is pivotable about the longitudinal axis LA with respect to the second link 48′. The seal lip 156 is connected to the second link 48. The load ring 152 is compressed against the load ring engagement surface 120 of the first link 48′, which defines, at least in part, the axially-extending seal cavity 118. The seal cavity 118 is disposed in proximal relationship to the second link 48′.

The load ring 152 acts as a gasket and sealingly engages the first link in the form of the outboard link 48′ of the adjacent track pin joint assembly 42′ and the seal ring 154. The first link engagement surface 222 of the load ring 152 engages the load ring engagement surface 120 of the first link 48′. As shown, the load ring 152 is placed in compression and the compression of the load ring 152 provides the sealing force to the seal ring 154, which in turn, transmits the axial sealing force to the seal lip 156, which is in sealing engagement against the sealing surface 214 of the seal ring 154. The load ring 152 acts in the manner of a spring to apply an axial load against the seal ring 154 along the longitudinal axis LA to sealingly engage the seal lip 156 mounted to the second link in the form of the outboard link 48 such that a running, fluid-tight seal is formed therebetween.

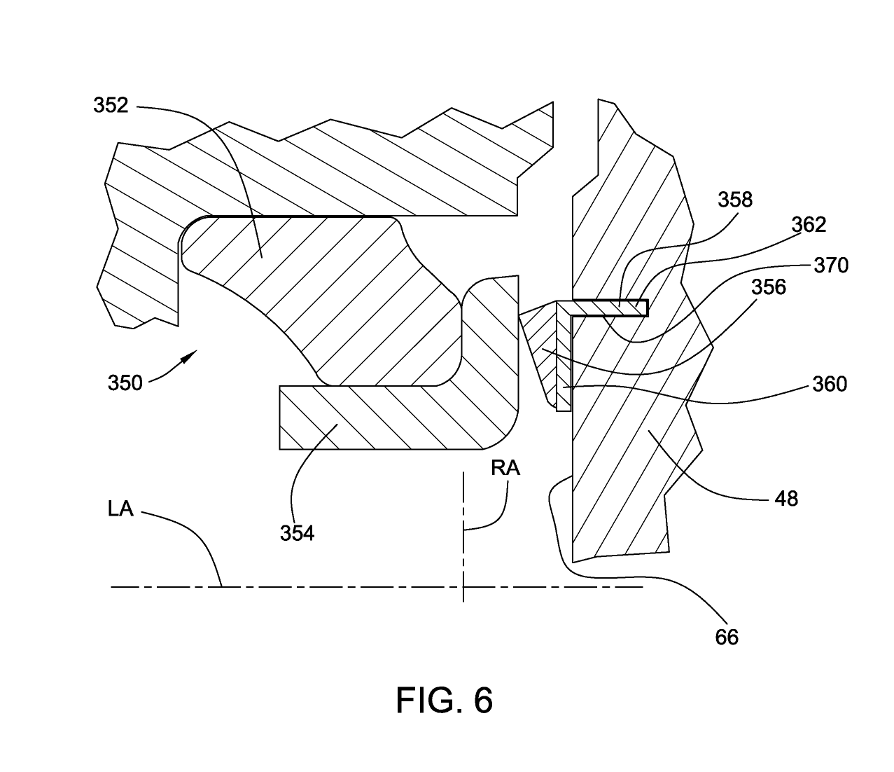

Referring to FIG. 6, another embodiment of a seal assembly 350 constructed in accordance with principles of the present disclosure is shown. The seal assembly 350 includes a load ring 352, a can or seal ring 354, a seal member in the form of a seal lip 356, and a mounting bracket 358.

The mounting bracket 358 is annular and includes a radial face 360 and a circumferential flange 362. The radial face 360 is annular and extends radially along a radial plane RA that is perpendicular to the rotational axis of the seal assembly 350 which coincides with the longitudinal axis LA of the pin 80. The circumferential flange 362 extends from the radial face 360 along the longitudinal axis LA.

The mounting bracket 358 can be made from any suitable material, such as, metal, for example. In embodiments, the seal ring 354 is made from at least one of a metal and a ceramic, the seal lip 356 is made from a plastic, and the mounting bracket 358 is made from a metal.

The seal lip 356 is connected to the second link 48 via a connection between the mounting bracket 358 and the second link 48. The seal lip 356 is connected to the radial face 360 of the mounting bracket 358. The second link in the form of the outboard link 48 has an exterior surface (the outer sidewall 66) that defines an annular groove 370 circumscribing the pin passage 70 of the second link. The circumferential flange 362 of the mounting bracket 358 is disposed within the annular groove 370.

In embodiments, any suitable technique can be used to connect the seal lip 356 to the mounting bracket 358. For example, the seal lip 356 can be insert molded to the mounting bracket 358. In other embodiments, the seal lip 356 can be mounted to the mounting bracket 358 using a suitable adhesive.

In embodiments, any suitable technique can be used to secure the mounting bracket 358 to the second link 48. For example, the mounting bracket 358 can be connected to the second link 48 by a press fit between the circumferential flange 362 and the exterior surface 66 defining the annular groove 370. In other embodiments, the mounting bracket 358 can be connected to the second link 48 using a suitable adhesive or by welding, for example. In some embodiments, the circumferential flange 362 of the mounting bracket 358 can be bonded to the exterior surface 66 defining the annular groove 370 using a suitable adhesive. In embodiments, the connection between the mounting bracket 358 and the second link 48 can be provided between the radial face 360 of the mounting bracket 358 and the exterior surface 66 of the link 48. The seal assembly 350 of FIG. 6 can be similar in other respects to the seal assembly 150 of FIG. 5.

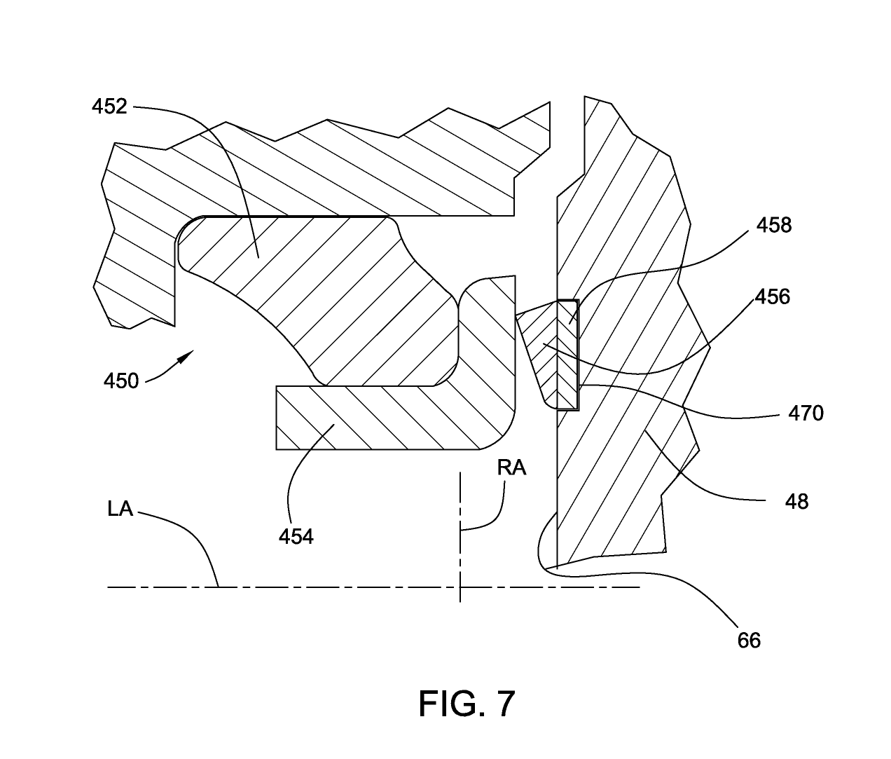

Referring to FIG. 7, another embodiment of a seal assembly 450 constructed in accordance with principles of the present disclosure is shown. The seal assembly 450 includes a load ring 452, a can or seal ring 454, a seal member in the form of a seal lip 456, and an annular disc 458.

The annular disc 458 can be made from any suitable material, such as, a thermoplastic polymer, including polycarbonate, for example. In embodiments, the seal ring 354 is made from at least one of a metal and a ceramic, the seal lip 356 is made from a plastic, and the annular disc 458 is made from a thermoplastic polymer.

The seal lip 456 is connected to the second link 48 via a connection between the annular disc 458 and the second link 48. The seal lip 456 is connected to the annular disc 458. The second link in the form of the outboard link 48 has an exterior surface (the outer sidewall 66) that defines an annular groove 470 circumscribing the pin passage 70 of the second link 48. The annular disc 458 is disposed within the annular groove 470 of the second link 48.

In embodiments, any suitable technique can be used to connect the seal lip 456 to the annular disc 458. For example, the seal lip 456 can be mounted to the annular disc 458 using a suitable adhesive.

In embodiments, any suitable technique can be used to secure the annular disc 458 to the second link 48. For example, the annular disc 458 can be connected to the second link 48 by a press fit between the annular disc 458 and the exterior surface 66 defining the annular groove 470. In other embodiments, the annular disc 458 can be connected to the second link 48 using a suitable adhesive, for example. In some embodiments, the annular disc 458 can be bonded to the exterior surface 66 such that the annular groove 470 can be omitted. The seal assembly 450 of FIG. 7 can be similar in other respects to the seal assembly 150 of FIG. 5.

### INDUSTRIAL APPLICABILITY

The industrial applicability of the embodiments of a track pin joint assembly and a track seal assembly described herein will be readily appreciated from the foregoing discussion. At least one embodiment of the disclosed seal assemblies may be used for a track pin joint assembly. At least one embodiment of the disclosed track pin joint assemblies can be used in an undercarriage of a track-type machine. An exemplary embodiment discloses a seal assembly for sealing between a first link and a second link of a joint, the first link being able to pivot about an axis of the joint relative to the second link.

In general, a seal assembly has been disclosed that can help retain lubricant within a track joint and resist the ingestion of mud and debris therein to help inhibit the occurrence of failure of the seal. During use, the seal assembly of a track pin joint assembly according to principles of the present disclosure may provide an abrasion-resistant and corrosion-resistant sealing system positioned between two relatively movable track links.

Embodiments of a seal assembly and a track pin joint assembly according to principles of the present disclosure may find potential application in any machine, such as a track-type tractor, which utilizes a track-type undercarriage. Yet further, the present disclosure may be applicable to track assemblies in which the components are subject to significant wear. Such machines may include, but are not limited to, dozers, loaders, excavators, or any other on-highway or off-highway vehicles or stationary machines that utilize a track assembly, as described herein.

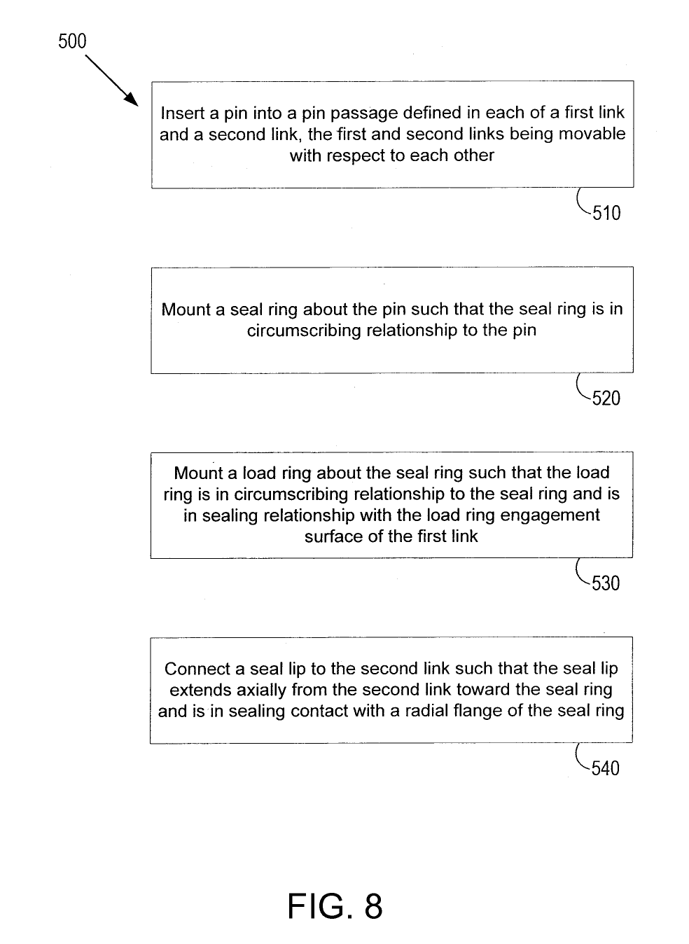

Referring to FIG. 8, steps of an embodiment of a method 500 for sealing a track joint following principles of the present disclosure are shown. The method 500 includes inserting a pin into a pin passage defined in each of a first link and a second link (step 510). The pin defines a longitudinal axis. The first link is pivotable about the longitudinal axis with respect to the second link. The first link includes a load ring engagement surface defining, at least in part, a seal cavity disposed in proximal relationship to the second link.

A seal ring is mounted about the pin such that the seal ring is in circumscribing relationship to the pin (step 520). The seal ring is disposed within the seal cavity. A load ring is mounted about the seal ring such that the load ring is in circumscribing relationship to the seal ring. The load ring is in sealing relationship with the load ring engagement surface of the first link (step 530).

A seal lip is connected to the second link such that the seal lip extends axially from the second link toward the seal ring and is in sealing contact with a radial flange of the seal ring (step 540). In embodiments, the seal lip is connected to the second link by being molded thereto. In some of such embodiments, the second link includes an exterior surface. The exterior surface defines an annular groove circumscribing the pin passage of the second link, and the seal lip is disposed within the annular groove.

In embodiments, the seal lip is connected to the second link by an adhesive. In some of such embodiments, the second link includes an exterior surface. The exterior surface defines an annular groove circumscribing the pin passage of the second link, and the seal lip being disposed within the annular groove.

In embodiments, the seal lip is connected to an annular disc. The second link includes an exterior surface which defines an annular groove circumscribing the pin passage of the second link. The annular disc is disposed within the annular groove. The seal lip is connected to the second link by connecting the annular disc to the second link. In some of such embodiments, the annular disc is connected to the second link by an adhesive. In some of such embodiments, the annular disc is connected to the second link by a press fit therebetween.

In embodiments, the seal lip is connected to a mounting bracket. The mounting bracket includes a radial face and a circumferential flange. The radial face is annular and extends along a radial plane perpendicular to the longitudinal axis. The circumferential flange extends from the radial face along the longitudinal axis. The seal lip is connected to the radial face of the mounting bracket.

The second link includes an exterior surface. The exterior surface defines an annular groove circumscribing the pin passage of the second link. The circumferential flange of the mounting bracket is disposed within the annular groove. The seal lip is connected to the second link by connecting the mounting bracket to the second link. In some of such embodiments, the mounting bracket is connected to the second link by an adhesive. In some of such embodiments, the mounting bracket is connected to the second link by a press fit between the circumferential flange of the mounting bracket and the exterior surface of the second link defining the annular groove.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A track pin joint assembly comprising:
a pin, the pin defining a longitudinal axis;
a first link and a second link, the first link and the second link each defining a pin passage receiving the pin therein, the first link being pivotable about the longitudinal axis with respect to the second link, the first link including a load ring engagement surface defining, at least in part, a seal cavity disposed in proximal relationship to the second link; and
a seal assembly, the seal assembly disposed in the seal cavity and sealingly disposed between the first link and the second link, the seal assembly comprising:
a seal ring, the seal ring being annular and having an axial flange extending along the longitudinal axis and a radial flange extending along a radial plane perpendicular to the longitudinal axis,
a load ring, the load ring being annular and including a seal ring engagement surface and a first link engagement surface, the seal ring engagement surface including an axial segment and a radial segment in engaging relationship with the axial flange and the radial flange of the seal ring, respectively, and the first link engagement surface in engaging relationship with the load ring engagement surface of the first link, and
a seal lip, the seal lip being annular and connected to the second link such that the seal lip circumscribes the pin passage and extends axially from the second link toward the seal ring, and the seal lip being in sealing contact with the radial flange of the seal ring.

2. The track pin joint assembly of claim 1, wherein the seal ring is made from at least one of a metal and a ceramic, and the seal lip is made from a plastic.

3. The track pin joint assembly of claim 1, wherein the second link includes an exterior surface, the exterior surface defining an annular groove circumscribing the pin passage of the second link, and wherein the seal lip is disposed within the annular groove of the second link.

4. The track pin joint assembly of claim 1, wherein the seal assembly includes an annular disc, the seal lip being connected to the annular disc, wherein the second link includes an exterior surface, the exterior surface defining an annular groove circumscribing the pin passage of the second link, the annular disc being disposed within the annular groove of the second link, and wherein the seal lip is connected to the second link via a connection between the annular disc and the second link.

5. The track pin joint assembly of claim 4, wherein the seal ring is made from at least one of a metal and a ceramic, the seal lip is made from a plastic, and the annular disc is made from a thermoplastic polymer.

6. The track pin joint assembly of claim 1, wherein the seal assembly includes a mounting bracket, the mounting bracket including a radial face and a circumferential flange, the radial face being annular and extending radially, the circumferential flange extending from the radial face along the longitudinal axis, the seal lip connected to the radial face of the mounting bracket, wherein the second link includes an exterior surface, the exterior surface defining an annular groove circumscribing the pin passage of the second link, the circumferential flange of the mounting bracket being disposed within the annular groove, and wherein the seal lip is connected to the second link via a connection between the mounting bracket and the second link.

7. The track pin joint assembly of claim 6, wherein the seal ring is made from at least one of a metal and a ceramic, the seal lip is made from a plastic, and the mounting bracket is made from a metal.

8. A track link for a track assembly, the track link comprising:
a body, the body including a first end, a second end, an outer sidewall and an inner sidewall, the outer sidewall and the inner sidewall extending along a body axis between the first end and the second end, the first end and the second end defining a first pin passage and a second pin passage, respectively, the first pin passage and the second pin passage each extending between the outer sidewall and the inner sidewall; and
a seal lip, the seal lip being annular, the seal lip connected to the body such that the seal lip circumscribes the first pin passage and extends from the outer sidewall of the body.

9. The track link of claim 8, wherein the inner sidewall of the body defines an annular counterbore circumscribing the second pin passage.

10. The track link of claim 9, wherein the outer sidewall of the body defines a first offset recess at the first end of the body, and the inner sidewall of the body defines a second offset recess at the second end of the body.

11. A method for sealing a track joint, the method for sealing comprising:
inserting a pin into a pin passage defined in each of a first link and a second link, the pin defining a longitudinal axis, the first link being pivotable about the longitudinal axis with respect to the second link, the first link including a load ring engagement surface defining, at least in part, a seal cavity disposed in proximal relationship to the second link;
mounting a seal ring about the pin such that the seal ring is in circumscribing relationship to the pin, the seal ring disposed within the seal cavity;
mounting a load ring about the seal ring such that the load ring is in circumscribing relationship to the seal ring, the load ring being in sealing relationship with the load ring engagement surface of the first link;
connecting a seal lip to the second link such that the seal lip extends axially from the second link toward the seal ring and is in sealing contact with a radial flange of the seal ring.

12. The method for sealing a track joint according to claim 11, wherein the seal lip is connected to the second link by being molded thereto.

13. The method for sealing a track joint according to claim 12, wherein the second link includes an exterior surface, the exterior surface defining an annular groove circumscribing the pin passage of the second link, the seal lip being disposed within the annular groove.

14. The method for sealing a track joint according to claim 11, wherein the second link includes an exterior surface, the exterior surface defining an annular groove circumscribing the pin passage of the second link, the seal lip being disposed within the annular groove, and wherein the seal lip is connected to the second link by an adhesive.

15. The method for sealing a track joint according to claim 11, further comprising:
connecting the seal lip to an annular disc; and
wherein the second link includes an exterior surface, the exterior surface defining an annular groove circumscribing the pin passage of the second link, the annular disc being disposed within the annular groove, and wherein the seal lip is connected to the second link by connecting the annular disc to the second link.

16. The method for sealing a track joint according to claim 15, wherein the annular disc is connected to the second link by an adhesive.

17. The method for sealing a track joint according to claim 15, wherein the annular disc is connected to the second link by a press fit therebetween.

18. The method for sealing a track joint according to claim 11, further comprising:
connecting the seal lip to a mounting bracket, the mounting bracket including a radial face and a circumferential flange, the radial face being annular and extending along a radial plane perpendicular to the longitudinal axis, the circumferential flange extending from the radial face along the longitudinal axis, the seal lip connected to the radial face of the mounting bracket; and
wherein the second link includes an exterior surface, the exterior surface defining an annular groove circumscribing the pin passage of the second link, the circumferential flange of the mounting bracket being disposed within the annular groove, and wherein the seal lip is connected to the second link by connecting the mounting bracket to the second link.

19. The method for sealing a track joint according to claim 18, wherein the mounting bracket is connected to the second link by an adhesive.

20. The method for sealing a track joint according to claim 18, wherein the mounting bracket is connected to the second link by a press fit between the circumferential flange of the mounting bracket and the exterior surface of the second link defining the annular groove.
